(19) United States
(12) Patent Application Publication
(10) Pub. No.: US 2012/0204428 A1
(43) Pub. Date: Aug. 16, 2012

(54) POSITIONING TUBE OF A VEGETATION CUTTER

(75) Inventor: TSUNG PEI YANG, Changhua (TW)

(73) Assignee: YAO I FABRIC CO, LTD., CHANGHUA (TW)

(21) Appl. No.: 13/027,398

(22) Filed: Feb. 15, 2011

(51) Int. Cl. A01D 34/416

(52) U.S. Cl. 30/276

(57) ABSTRACT

A vegetation cutter includes a tubular casing and a power source is connected to a first end of the casing so as to drive a drive cable which extends through the casing. A cutting member is connected to the drive cable and located on a second end of the casing. A positioning tube is axially located in the casing and has an annular sleeve through which the drive cable extends. The sleeve has two rib portions tangentially connected thereto and the two rib portions are parallel to each other. Each rib portion has two ribs on two ends thereof and the two ribs contact an inner periphery of the casing. The ribs are flexible and position the positioning tube in the casing, and absorb vibration when in use.

### FIELD OF THE INVENTION

The present invention relates to a positioning tube for a vegetation cutter, and more particularly, to a positioning tube with ribs which, are flexible and in contact to inside of the positioning tube.

### BACKGROUND OF THE INVENTION

A conventional vegetation cutter generally includes a tubular casing with a power source and a cutting member connected to two ends of the casing. A flexible drive cable extends through the casing and is driven by the power source so as to rotate the cutting member which cuts the plants. The cutting member can be a blade or a cutting line.

A positioning tube is located in the casing and located between the drive cable and the casing. Multiple ribs extend from the positioning tube. When the power source is activated, the drive cable generates vibration which can be absorbed by the positioning tube and reduces friction between the drive cable and the casing.

A conventional positioning tube is disclosed in U.S. Pat. No. 6,739,058 and comprises a pipe portion with a inner pipe portion received therein, three radial stay portions connected between the inner pipe portion and the pipe portion. A drive shaft extends through the inner pipe portion and is driven by a drive source unit and a cutter blade is connected to the drive shaft. The cutter blade is rotated when the drive source unit is activated. The three radial stay portions are located at different spaces and angles relative to each other. The inner pipe portion and the pipe portion are integrally connected to each other.

Another conventional positioning tube is disclosed in U.S. Pat. No. 4,953,294 and comprises a housing for accommodating the motor therein; a protective tube which can be subjected to vibrations during operational use of the tool, the protective tube having a rearward end connected to said housing and having a forward end, said tube also having an inner wall surface; a work tool assembly mounted on said forward end; a drive shaft mounted in said protective tube for connecting said motor to said work tool assembly; a bearing sleeve unit arranged in said protective tube and which can be subjected to radial pressure forces when mounted in said tube; said bearing sleeve unit including an annular-like center portion defining a bearing opening for holding and guiding said drive shaft within said protective tube, said center portion having an outer surface in spaced relationship to said inner wall surface of said protective tube; said bearing sleeve unit further including a plurality of supporting ribs extending outwardly from said outer surface to brace said bearing sleeve unit against said inner wall surface for supporting and centering said bearing sleeve unit within said protective tube; and at least one of said ribs being configured to extend approximately tangentially to said annular-like center portion so as to be resilient in a direction extending radially outwardly from said annular-like center portion thereby substantially isolating said annular-like center portion from said pressure forces and said protective tube from said vibrations.

The first conventional positioning tube disclosed in U.S. Pat. No. 6,739,058 includes three radial stay portions which are complicated in shape and include the weight of the tool. The U.S. Pat. No. 4,953,294 discloses multiple supporting ribs and one of the ribs is resilient. Nevertheless, the multiple supporting ribs are not convenient for assembling in the protective tube. Furthermore, both of the two disclosures require precisely machining and a small range of tolerance is allowed because of their specific shapes. The sizes of the parts may change due to change of temperature and the change of sizes might stock the positioning tube in the casing. The precisely machined positioning tube cannot be assembled quickly and easily.

### SUMMARY OF THE INVENTION

The present invention relates to a vegetation cutter and comprises a tubular casing with a power source and a cutting member connected to two ends thereof. A drive cable extends through the casing and is connected to the power source. The cutting member is connected to and driven by the drive cable. A positioning tube is axially located in the casing and has an annular sleeve through which the drive cable extends. The sleeve has two rib portions tangentially connected thereto and the two rib portions are parallel to each other. Each rib portion has two ribs on two ends thereof and the two ribs contact an inner periphery of the casing. The ribs are flexible so that the positioning tube is easily positioned in the casing by deforming the ribs. The positioning tube has a simple structure and is light in weight.

The primary object of the present invention is to provide a positioning tube with an annular sleeve so that the drive cable extends through the annular sleeve. The sleeve has two flexible ribs connected thereto and the two ribs contact an inner periphery of the casing. The ribs are flexible so that the positioning tube is easily positioned in the casing by deforming the ribs.

Another object of the present invention is to provide a positioning tube which includes an annular sleeve and two rib portions. The positioning tube is easily manufactured and light in weight. The positioning tube can be made by resilient material.

Yet another object of the present invention is to provide a positioning tube with two rib portions which are in contact with the inner periphery of the casing at four contact points. The positioning tube can be made with larger range of tolerance.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the vegetation cutter with the positioning tube of the present invention received therein;

FIG. 2 is a cross sectional view taken along line 2-2 in FIG. 1, and

FIG. 3 is a perspective view to show the positioning tube of the present invention.

### DETAILED DESCRIPTION OF THE PREFERRED EMBODIMENT

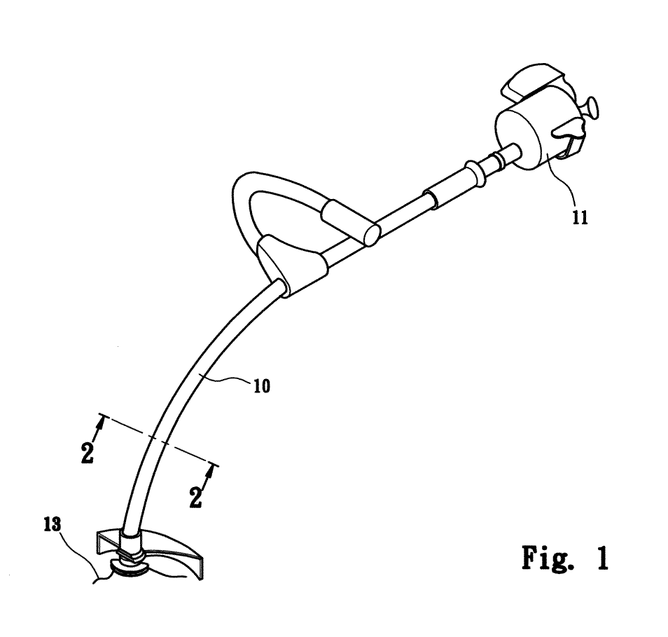

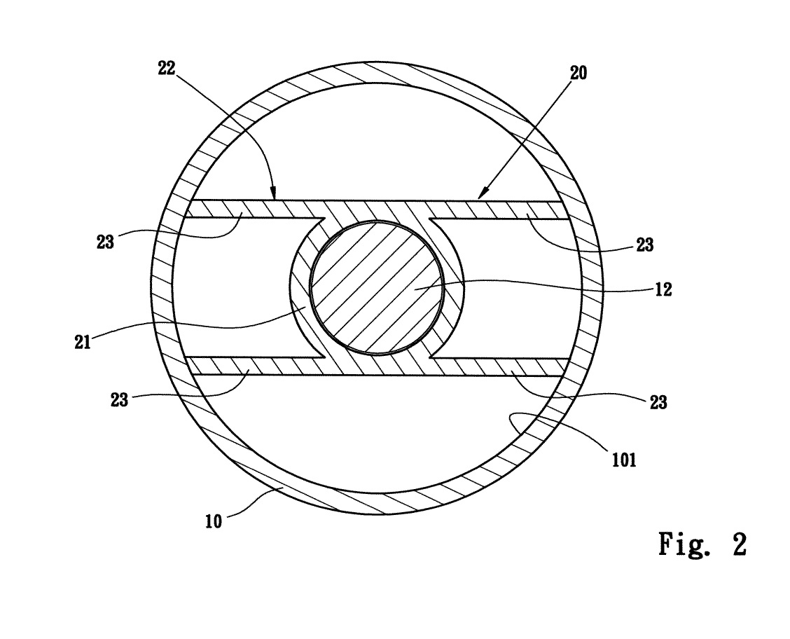

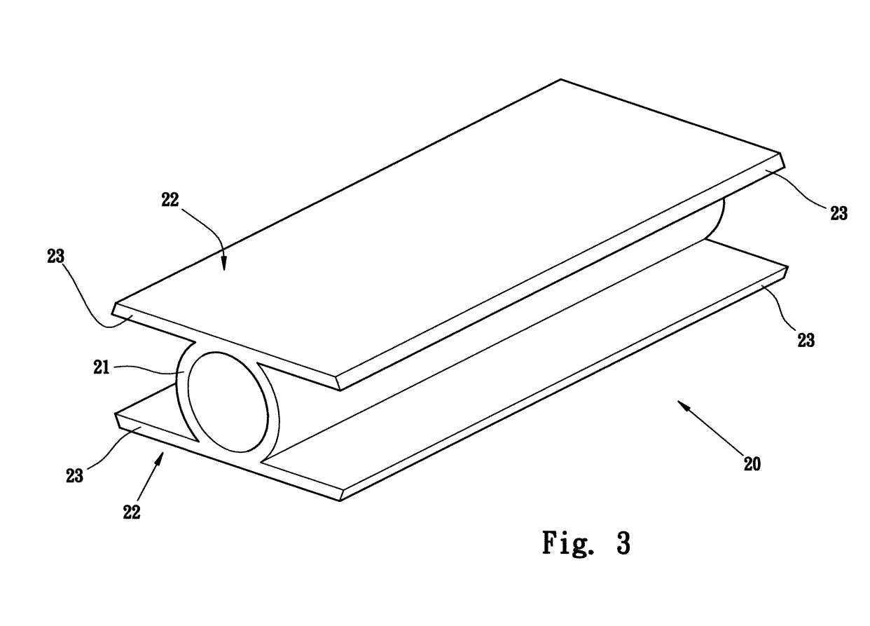

Referring to FIGS. 1 to 3, the vegetation cutter generally comprises a tubular casing 10, power source 11 connected to the first end of the casing 10, a cutting member 13 connected to the second end of the casing 10, and a positioning tube of the present invention received in the casing 10.

The power source 11 is a motor or an engine, and a drive cable 12 is connected to the power source 11 and driven by the power source 11. The drive cable 12 extends through the casing 10 and is made of metal and includes proper flexible and preset torque.

The cutting member 13 is connected to the drive cable 12 and rotated by the drive cable 12. The cutting member 13 is a blade or a cutting line.

The positioning tube 20 is axially located in the casing 10 and has an annular sleeve 21 through which the drive cable 12 rotatably extends. The sleeve 21 has two rib portions 22 tangentially connected thereto and the two rib portions 22 are parallel to each other. Each rib portion 22 has two ribs 23 on two ends thereof and the two ribs 23 contact the inner periphery 101 of the casing 10. The two ribs 23 are flexible and can be bent toward the center of the sleeve 21. By the flexibility, the positioning tube 20 can be easily installed in the casing 10. When the positioning tube 20 is installed in the casing 10, the ribs 23 are released and bounce back to contact the inner periphery 101 of the casing 10. There are four contact points between the positioning tube 20 and the casing 10 to well position the positioning tube 20. By the flexibility of the ribs 23, the positioning tube 20 can also be easily removed from the casing 10. The positioning tube 20 absorbs vibration from the casing 10. The positioning tube 20 is made of PA, PET, or TPEE which is light in weight.

The positioning tube 20 is made by resilient material such as rubber and the rib portions 22 and the sleeve 21 can be integrally manufactured. Because the ribs 23 can be deformed, the positioning tube 20 does not need to be manufactured to have high precision standard. The range of tolerance can be larger which reduces the manufacturing cost and the size change due to temperature does not affect the contact between the ribs 23 and the casing 10.

Because there are four rib portions 22 extending from the sleeve 21, so that when installing the positioning tube 20 in the casing 10, one or two ribs 23 can be bent toward the sleeve 21 to have more space to allow the positioning tube 20 to be inserted into the casing 10. The ribs 23 can bounce back to contact the inner periphery 101 of the casing 10 when the positioning tube 20 is set in the casing 10. There are only four rib portions 22 on the sleeve 21 so that the manufacturing cost can be lowered.

While we have shown and described the embodiment in accordance with the present invention, it should be clear to those skilled in the art that further embodiments may be made without departing from the scope of the present invention.

What is claimed is:

1. A vegetation cutter comprising:
a tubular casing;
a power source connected to a first end of the casing, a drive cable connected to the power source and extending through the casing;
a cutting member connected to the drive cable and located on a second end of the casing, the cutting member being rotated by the drive cable, and
a positioning tube axially located in the casing and having an annular sleeve through which the drive cable extends, the sleeve having two rib portions tangentially connected thereto and the two rib portions being parallel to each other, each rib portion having two ribs on two ends thereof and the two ribs contacting an inner periphery of the casing.

2. The vegetation cutter as claimed in claim 1, wherein the power source is a motor or an engine.

3. The vegetation cutter as claimed in claim 1, wherein the cutting member is a blade or a cutting line.

4. The vegetation cutter as claimed in claim 1, wherein the positioning tube is made of PA, PET, or TPEE.
